(19) United States
(12) Patent Application Publication
(10) Pub. No.: US 2003/0065906 A1
(43) Pub. Date: Apr. 3, 2003

(54) ASAP instruction caching

(76) Inventors: Ryan N. Rakvic, San Jose, CA (US); Hong Wang, Fremont, CA (US); John P. Shen, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/968,475

(22) Filed: Sep. 28, 2001

(51) Int. Cl. G06F 9/30

(52) U.S. Cl. 712/207

(57) ABSTRACT

A system and method of storing instructions is disclosed. First an instruction is received. Then if the instruction will be used in a next instruction cycle, the instruction is loaded in a next instruction cycle cache memory.

### FIELD OF THE INVENTION

The disclosed invention relates to computer memory management and more specifically to the management of cache memory systems.

### BACKGROUND OF THE INVENTION

Most modern computers include several types of memory for data and instruction storage. Each of these various types of memory are used for varying purposes. These types include the main memory and cache memory. The main memory can also include several types of memory: random access memory (RAM), dynamic random access memory (DRAM), mass storage such as a hard disk or other magnetic or optical storage media.

Cache memory is a portion of the memory that is physically located closer to the processor and thereby reduces access time i.e. the number of clock cycles required to fetch an instruction or data from cache. There are several levels of cache known in the art, as examples: Level 1 (L1) cache is typically on the same die as the processor i.e. on the same chip. Fetching instructions from Level 2 (L2) cache typically requires 10-15 and possibly more cycles. In comparison, fetching instructions or data from main memory can require 1000 or more cycles. L1 and L2 cache are typically very high-speed memory cells where other portions of memory such as main memory RAM may be slower speed memory cells.

The goal of the L1 cache is to provide a memory location close enough to the processor that the instructions can be fetched from the L1 cache within the one clock cycle. However, as processor speeds have increased to 1 GHz and beyond, the time required to fetch instructions or data from the L1 cache has begun to exceed the less than 1 nanosecond time span of each clock cycle. Therefore, one or more additional clock cycles are often required to fetch instructions from the L1 cache.

It is generally preferable to have a smaller L1 cache that can be fully fetched in one or at most two clock cycles, but that must be reloaded more often, than a larger L1 cache that requires more than two clock cycles to fully fetch. Therefore, one method to reduce the fetch time is to reduce the overall capacity of the L1 cache. For example in a typical 100 MHz processor, the L1 cache was approximately 32 kilobytes (32 k) and a typical 500 MHz processor typically has 16 k of L1 cache. Processors that are even faster than 500 MHz often have L1 cache of even less than 16 k. While L1 cache is typically getting smaller, the instructions are typically getting larger.

### BRIEF DESCRIPTION OF THE DRAWINGS

The present invention is illustrated by way of example and not limitation in the figures of the accompanying drawings in which like references indicate similar elements.

FIG. 1 illustrates a high-level block diagram of a computer system.

FIGS. 2A and 2B illustrate alternative embodiments of the cache memory system.

FIG. 3 shows one embodiment of an instruction pipeline processing an instruction.

FIG. 4 shows one embodiment of a process of the instruction logic 304.

FIG. 5 illustrates an alternative embodiment of the execution stage 330 shown in FIG. 3.

FIG. 6 illustrates one embodiment of processing a branching instruction to substantially minimize stalls.

FIG. 7 illustrates one method of minimizing a stall caused by a stall causing instruction.

### DETAILED DESCRIPTION

As will be described in more detail below, a more efficient system and method of using cache memory is described. In one embodiment, cache memory can be divided into instruction and data portions such that instructions and data are separated into a corresponding instruction cache and data cache. The cache memory can also be divided into an n-cycle portion that is accessible by the processor in a predetermined number (n) clock cycles and an instruction cycle portion. Any instructions that are needed within the predetermined number of clock cycles but more than one instruction cycle, i.e. the next instruction cycle, can be stored in the n-cycle portion of the cache. The instructions used in the next instruction cycle can be stored in the instruction cycle cache.

One embodiment includes an improved method of managing the L1 cache in a processor. The L1 cache can be divided into an instruction cache and a data cache. Instructions and data are separated and temporarily stored into the corresponding instruction cache and a data cache. Another embodiment includes a method of sorting the incoming instructions so that the instructions are separated into instructions that are to be used in the next instruction cycle and those instructions that will be used in a later clock cycle.

In one embodiment, the latency of an instruction is substantially matched to the latency of the memory location in which the instruction is stored. An improved prioritization of instructions based on their respective latency allows the instruction cache to be more efficient and therefore, smaller. Instructions can be fetched faster from a smaller instruction cache.

One cause of latency in instructions is a stall causing instruction. There are generally two types of stalls. The first type of stall is a bubble and the second type of stall is an instruction that requires a long time to execute such as a loading or storing instruction that loads or stores data from or into the main memory.

A bubble occurs when a branching instruction is received and one of the branches is predicted, fetched and executed. If the predicted branch is then determined to be incorrectly predicted, the non-predicted branch must be fetched and executed. The bubble is caused by the lost processing time that was wasted on the unneeded instruction processing of the incorrectly predicted branch.

For example, the following branching instruction (Instruction 1) is received:

If Y=0 then X=0, else X=1 Instruction 1

Instruction 1 is a branching instruction because X=0 and X=1 each represent a branch of instructions. Which branch, X=0 or X=1 that may be the correct branch depends on the ultimate value of Y (i.e. Y=1 or Y=0), one branch of instructions or the other will be utilized. When Instruction 1 is received, the value of Y is not yet known. Branch predicting allows the processor to continue processing a predicted branch. It is well known in the art that a most likely to succeed branch of a branching instruction can be predicted by various methods. For example if X=0, is predicted to be successful (i.e. the predicted branch) then the predicted branch is loaded into the instruction cache and the non-predicted branch, X=1, is loaded into an n-cycle cache. If the X=0 branch is then determined to be incorrectly predicted, then the X=1 branch must be fetched.

A stall can follow a bubble because, once the bubble occurred (i.e. the predicted branch is determined to be incorrectly predicted) the non-predicted branch must then be fetched. Fetching the non-predicted branch can cause a stall while the non-predicted branch is fetched from L2 (a 10-15 cycle stall) or main memory (approximately 1000 cycles or more stall). However, if the non-predicted branch is, available in the next instruction cycle, i.e. in the non-predicted branch is at that point in time stored in the instruction cycle cache, after the predicted branch is determined to be incorrectly predicted, then any resulting stall is minimized.

A loading or storing instruction can often cause stalls because the data being loaded or stored must come from or go to main memory and can require 1000 clock cycles or more to complete the journey to or from main memory. If the data can be fetched from a data cache then the stall due to the load is minimal or even non-existent. If, however, the load causes a stall, then the various buffers in the pipeline can fill-up and the processor will stall while waiting for the data. The processor is typically unable to process other instructions when the pipeline buffers are all filled.

Because instructions that depend on a load (or other stall causing instruction) are not going to be needed in the next instruction cycle, then, the depending instructions that depend on the stall causing instruction can be placed in n-cycle cache or other memory so long as the depending instructions are available for execution when or shortly after (i.e. within a few cycles after) the stall ends.

Ideally, a stall causing instruction should get to the processor as soon as possible so that the stall occurs as soon as possible. Stall causing instructions can also be predicted similar to branch prediction discussed above.

In one embodiment, if a branching instruction is received, then one branch is predicted as being the most likely branch and the first instruction in the predicted branch is moved into the instruction cache. The first instruction in the non-predicted branch is moved to a second portion of the cache memory that is not necessarily accessible within the next instruction cycle, i.e. into the n-cycle portion of the cache. In one embodiment the n-cycle cache memory is accessible in a number of clock cycles equal to the number of clock cycles required to determine if the predicted branch is the correct branch. As described above, the first instructions of the predicted branch are fetched and further processed in the processor and, if the predicted branch is later determined to be the incorrect branch, then the first instruction of the non-predicted branch can then be fetched in the then next occurring clock cycle.

For example, if five clock cycles are required to process the predicted branch to a point that the predicted branch can be determined to be correctly predicted, then the non-predicted instruction would be stored in a portion of the cache accessible in five clock cycles. Therefore, if, on the fifth clock cycle from when the predicted branch was fetched, the predicted branch is determined to be the incorrect branch, then the non-predicted branch can then be fetched during the next clock cycle, i.e. a sixth clock cycle from when the predicted branch was fetched. Thereby any stalls resulting from an incorrectly predicted branch are substantially reduced and the instruction cache can be very small such that instructions needed in the next instruction cycle can be fetched within one instruction cycle.

In one embodiment, each instruction may require more than one clock cycle to fetch from the cache memory and therefore, the fetch is described in terms of “instruction cycles”. For example, if two clock cycles are required to fetch an instruction then and instruction cycle is equal to two clock cycles. In one alternative embodiment, if the instruction requires X clock cycles to fetch, then the n-cycle cache as described above is actually X+n-cycle cache, i.e. cache memory that an instruction can be fetched in an (X)+(n) clock cycles.

In another alternative, the n-cycle cache can be slightly more or less than the number of cycles required to determine if the predicted branch is the correct branch. For example, if five instruction cycles are required to determine if the predicted branch is the correct branch, then n-cycle cache could be five or even six instruction cycle cache. Five instruction cycle cache would have the non-predicted branch available in the next instruction cycle after the predicted branch is determined to be the incorrect branch. Six instruction cycle cache would result in a short, one instruction cycle stall. A one instruction cycle stall is substantially less of a stall than a five instruction cycle or more stall caused by not having the non-predicted branch in the n-cycle cache. Similarly, a seven or even eight instruction cycle cache could be used and still yield substantially reduced stalls caused by predicting the incorrect branch.

In one embodiment, n can be equal to or less than the number of cycles required to determine if the predicted branch is the correct branch. Alternatively, n can be equal to or greater than the number of cycles required to determine if the predicted branch is the correct branch.

Because the instructions stored in the n-cycle cache are not used in the next instruction cycle, then n-cycle cache can be any memory location in the computer system that the processor can fetch in instruction in the needed number of cycles, i.e. n cycles. Therefore, if an instruction can be fetched from the mass storage device 110 within n cycles, then conceivably the n-cycle cache could be part of the mass storage device 110. Alternatively, the n-cycle cache can be part of L1 cache, L2 cache or a separate cache memory location, in addition to the traditional L1 and L2 cache memories.

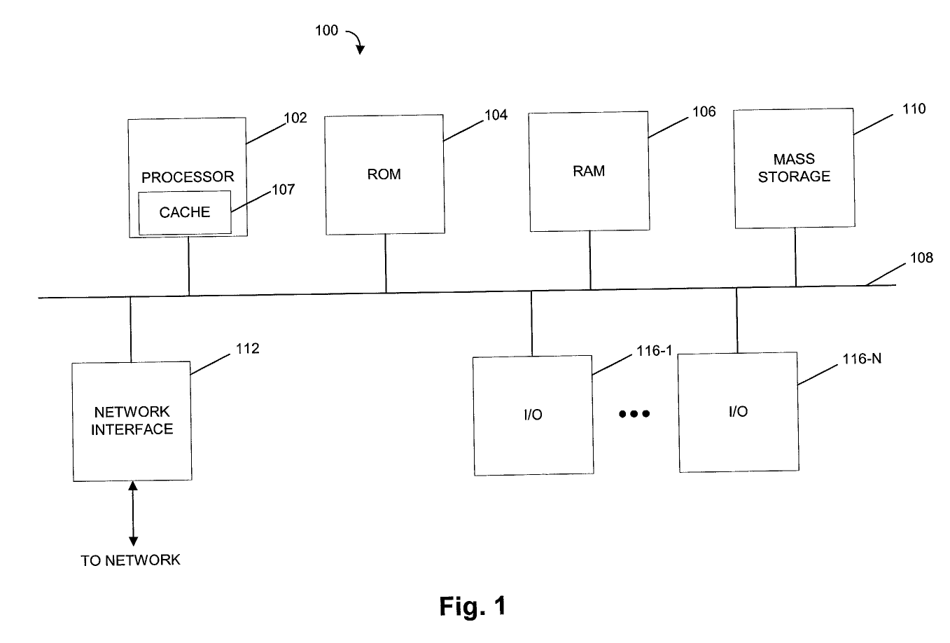

FIG. 1 illustrates a high-level block diagram of a computer system representative of any computer such as a personal computer (PC) or a server or other type of computer system. As shown, the computer system includes a processor 102, ROM 104, RAM 106, and a mass storage device 110 each connected to a bus system 108. The bus system 108 may include one or more buses connected to each other through various bridges, controllers and/or adapters, such as are well known in the art. For example, the bus system 108 may include a “system bus” that is connected through an adapter to one or more expansion buses, such as a Peripheral Component Interconnect (PCI) bus. Also coupled to the bus system 108 are a network interface 112, and a number (N) of input/output (I/O) devices 116-1 through 116-N.

I/O devices 116-1 through 116-N may include, for example, a keyboard, a pointing device, a display device and/or other conventional I/O devices. Mass storage device 110 may include any suitable device for storing large volumes of data, such as a magnetic disk or tape, magneto-optical (MO) storage device, or any of various types of Digital Versatile Disk (DVD) or Compact Disk (CD) based storage.

Network interface 112 provides data communication between the computer system and other computer systems such as on a network. Hence, network interface 112 may be any device suitable for or enabling the computer system 100 to communicate data with a remote processing system over a data communication link, such as a conventional telephone modem, an Integrated Services Digital Network (ISDN) adapter, a Digital Subscriber Line (DSL) adapter, a cable modem, a satellite transceiver, an Ethernet adapter, or the like.

Of course, many variations upon the architecture shown in FIG. 1 can be made to suit the particular needs of a given system. Thus, certain components may be added to those shown in FIG. 1 for given system, or certain components shown in FIG. 1 may be omitted from the given system.

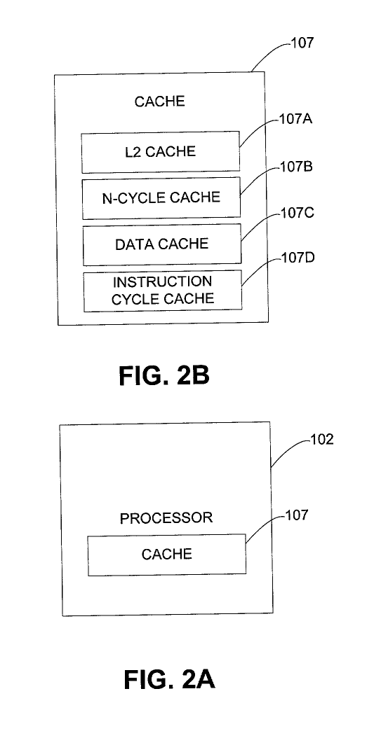

In one embodiment, the Processor 102 also includes a cache memory system 107. FIGS. 2A and 2B illustrate alternative embodiments of the cache memory system 107. In FIG. 2A, the cache memory system 107 is located on the same die as the processor 102. In one alternative embodiment shown in FIG. 2B, the cache memory system 107 is subdivided into several parts: L2 cache 107A, n-cycle cache 107B, data cache 107C and instruction cycle cache 107D. Each one of the parts of the cache memory system 107 can be co-located or alternatively can be distributed throughout the computer system in any one or more of the locations described herein. As will be described in more details below, data and instructions can be separated and stored in respective data cache 107C and instruction cycle cache 107D. The data and instructions are separated to more easily fetch, store and execute the instructions and data. The instruction cycle cache 107D can be in whatever location, i.e. on the die with the processor, not on the processor's die, etc., as long as the processor can fetch an instruction stored in the instruction cycle cache 107D, in one instruction cycle.

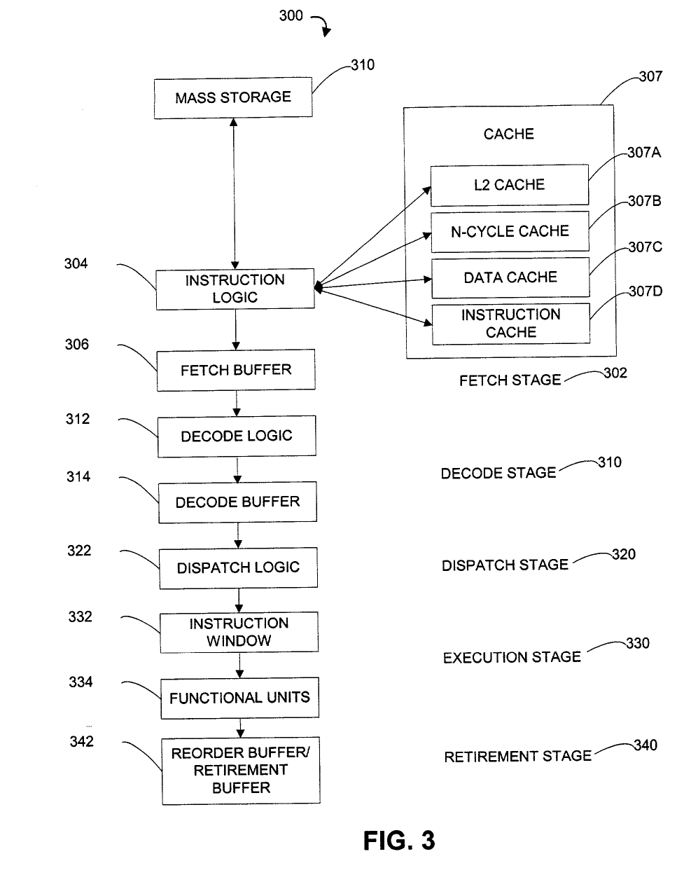

FIG. 3 shows one embodiment of an instruction pipeline processing an instruction. The pipeline 300 includes a fetch stage 302, a decode stage 310, a dispatch stage 320, an execution stage 330, and a retirement stage 340. In the fetch stage 302, an instruction is retrieved from the mass storage 110 by the instruction logic 304. The instruction logic 304 distributes the instruction into the cache memory system 107. The instructions are distributed by the instruction logic 304 as described above. Also in the fetch stage 302, data may also be fetched from the mass storage 110 and distributed to the data cache 107C. The instruction logic also places the next instruction to be processed in the fetch buffer 306.

In the decode stage 310, the decode logic 312 decodes the instruction from the fetch buffer 306. The decoded instruction is then stored in the decode buffer 314. In the dispatch stage 320, the dispatch logic 322 dispatches the decoded instructions to the execution stage 330.

The execution stage 330 includes an instruction window 332 and a functional unit 334. The instruction window is a buffer that holds the next decoded instruction to be executed in the functional unit 334. As will be described in more detail below, the execution stage 330 can include multiple instruction windows and functional units.

Once the instruction has been executed the instruction is retired in the retirement stage 340. In an out-of-order processor, the results of the executed instructions are accumulated in a reorder buffer and then place in order in a retirement buffer 342. In an in-order processor, the results of the executed instructions are accumulated in the retirement buffer 342. The in-order results are then stored in mass storage from the retirement buffer 342. Additional stages could be also included in the pipeline. The execution stage may also include additional buffers and stages for out-of order processing.

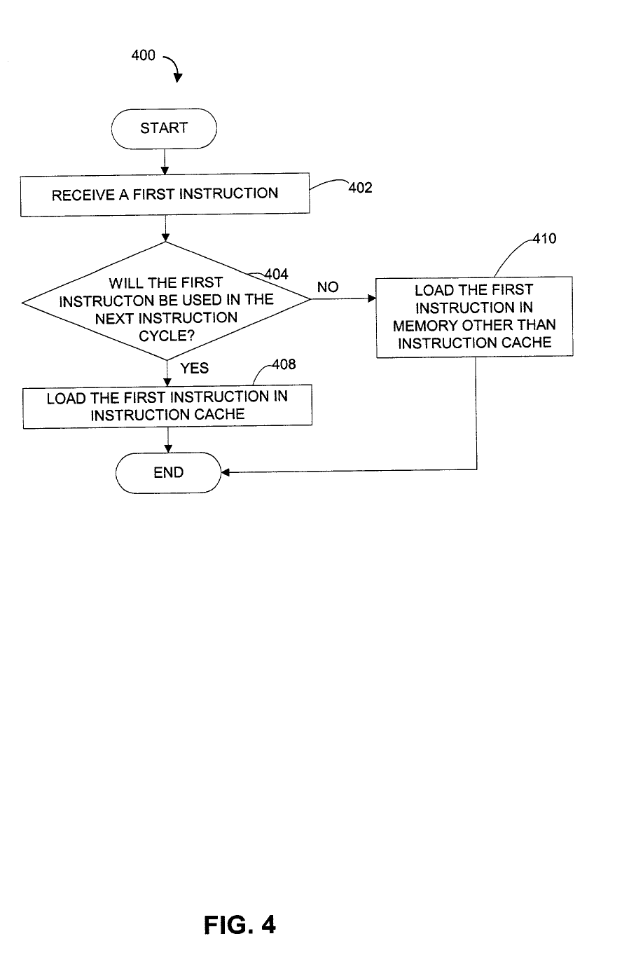

FIG. 4 shows one embodiment of a process of the instruction logic 304. A first instruction is received in block 402. The first instruction is analyzed in block 404 to determine if the first instruction will be used in the next instruction cycle. If the first instruction will be used in the next instruction cycle, then the first instruction is loaded in the instruction cycle cache in block 408. Alternatively, if in block 404, the first instruction is not to be used in the next instruction cycle, then the first instruction is loaded into a memory location other than instruction cache, i.e. n-cycle cache or then memory location.

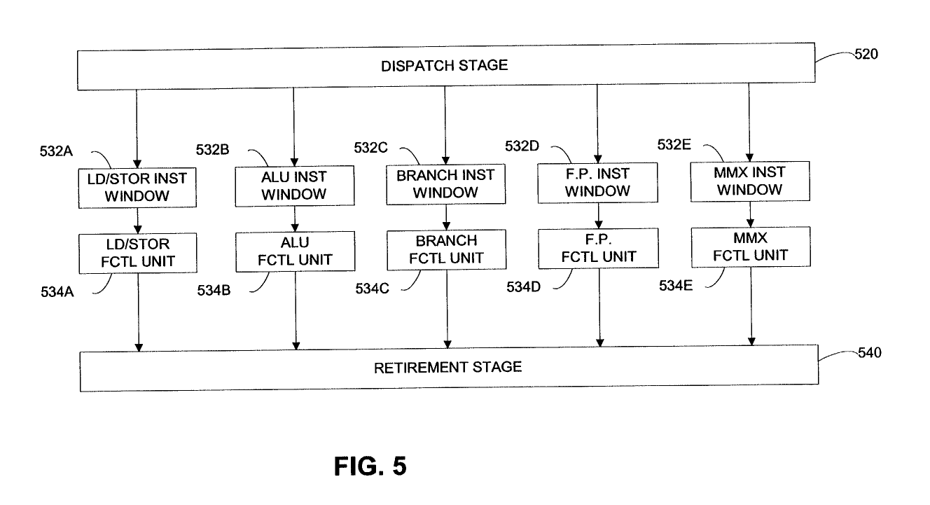

FIG. 5 illustrates an alternative embodiment of the execution stage 330 shown in FIG. 3. FIG. 5 shows multiple instructions windows 332A, 332B, 332C, 332D, 332E and functional units 334A, 334B, 334C, 334D, 334E. Each of the functional units 334A, 334B, 334C, 334D, 334E are optimized for their respective functions. For example, load/store instructions are placed in the LD/STOR instruction window 332A and the LD/STOR functional unit 334A is optimized to execute load and store functions. Similarly, arithmetic instructions are processed through the arithmetic logic unit (ALU) window 332B and the ALU functional unit 334B. Branching instructions are processed through the branch instruction window 332C and the branch functional unit 334C. Floating point type instructions are processed through the FP instruction window 332D and the FP functional unit 334D. Multimedia extension type (MMX) instructions are processed through the MMX instruction window 332E and the MMX functional unit 334E. Additional or alternative windows and functional units can also be included in the multiple instruction windows 332A, 332B, 332C, 332D, 332E and functional units 334A, 334B, 334C, 334D, 334E.

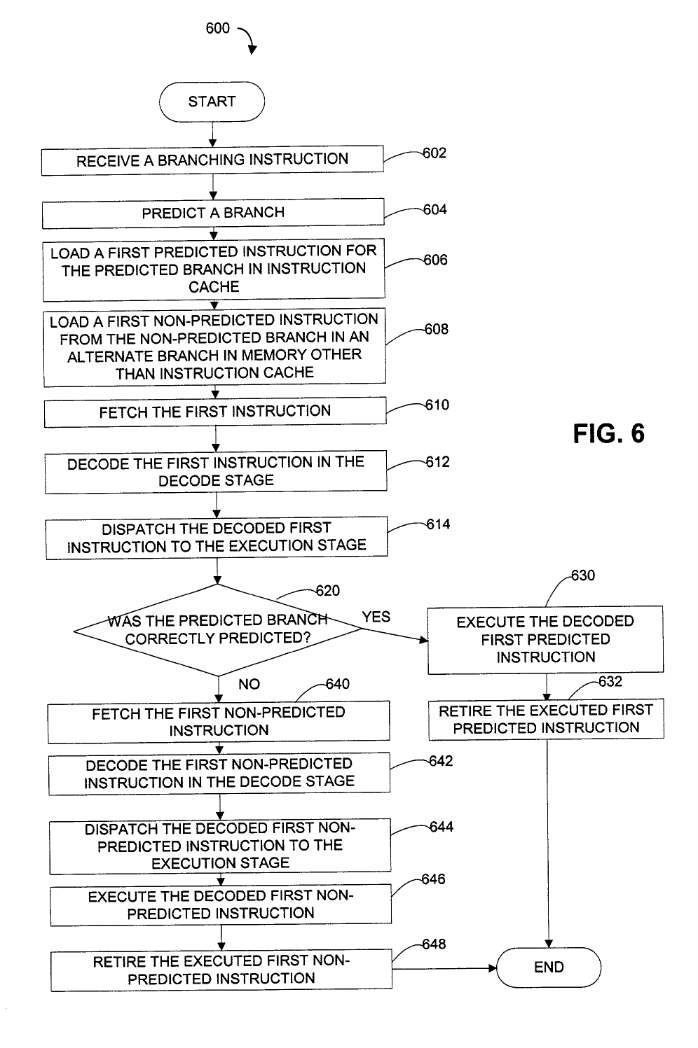

FIG. 6 illustrates one embodiment of processing a branching instruction to substantially minimize stalls. A branching instruction is received in block 602. Next, one of the branches of the branching instruction is predicted to be successful in block 604. Any one or more of the several methods that are well known in the art for predicting the likely success of a branch instruction can be used to predict a likely successful branch. A first predicted instruction of the predicted branch is loaded in the instruction cycle cache in block 606. A first non-predicted instruction from the non-predicted branch is loaded in another portion of memory other than the instruction cache in block 608, i.e. n-cycle cache, such as described above. The first predicted instruction is then fetched in block 610. The first predicted instruction is then decoded in block 612. Additional predicted instructions that are subsequent to the first predicted instruction in the predicted branch may also be processed after the first predicted instruction, if necessary, to determine if the predicted branch was correctly predicted. The decoded first instruction is then dispatched in block 614. Next, in block 620, the predicted branch is analyzed to determine if the predicted branch was correctly predicted.

If the predicted branch was correctly predicted in block 620, then the decoded first predicted instruction is executed in block 630 and retired in block 632. Alternatively, if the predicted branch was not correctly predicted in block 620, then the first non-predicted instruction is fetched in block 640. The first non-predicted instruction is then decoded in the decode stage in block 642. The decoded first non-predicted instruction is then dispatched in block 644. The dispatched, decoded, first non-predicted instruction is then executed in block 646 and retired in block 648.

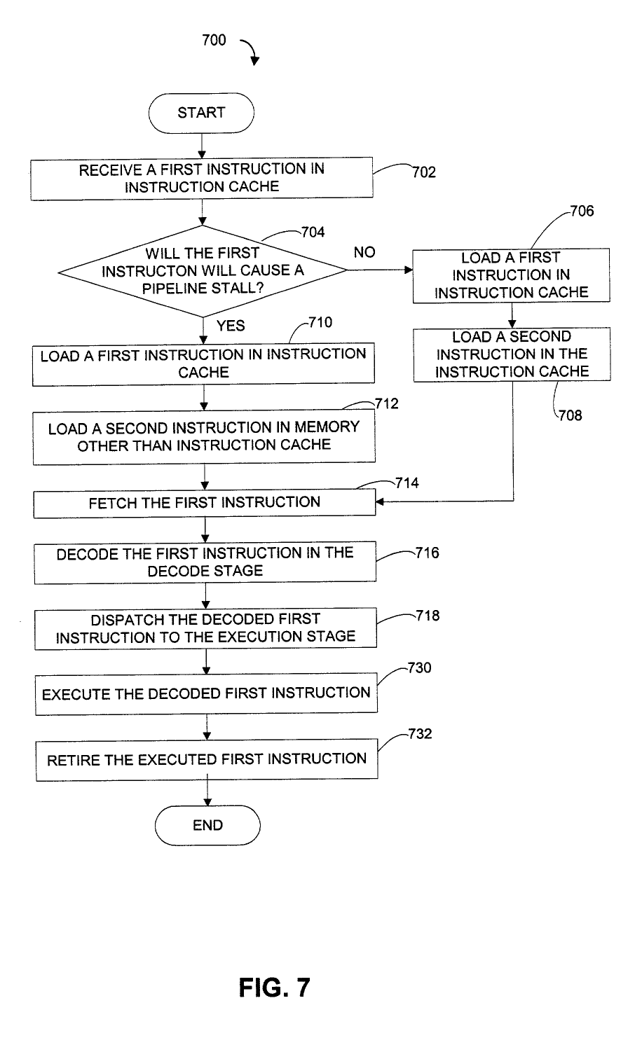

FIG. 7 illustrates one method of minimizing a stall caused by a stall causing instruction. A first instruction is received in the instruction cycle cache in block 702. Next, the first instruction will be analyzed to determine if the first instruction will cause a pipeline stall in block 704. If the first instruction will not cause a stall, then the first instruction is loaded in the instruction cycle cache in block 706 and a second instruction is loaded in the instruction cache in block 708. The first instruction is then fetched from the instruction cycle cache in block 714.

Alternatively, if the first instruction will cause a stall, then the first instruction is loaded in the instruction cache cycle in block 710 and a second instruction is loaded in the memory other than the instruction cycle cache in block 712. The first instruction is then fetched from the instruction cycle cache in block 714. The first instruction is decoded in the decode stage in block 716. The decoded first instruction is executed in block 730 and retired in block 732. In one embodiment, the location in memory where the second instruction is stored in block 712, is accessible by the processor in n instruction cycles.

It will be further appreciated that the instructions represented by the blocks in FIGS. 4, 6, and 7 are not required to be performed in the order illustrated, and that all the processing represented by the blocks may not be necessary to practice the invention.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method of storing instructions comprising:
receiving an instruction;
determining if the instruction will be used in a next instruction cycle; and
loading the instruction in a cache memory if the instruction will be used in the next instruction cycle.

2. The method of claim 1, wherein the instruction cycle includes no more than two clock cycles.

3. The method of claim 1, further comprising loading the instruction in a memory location that is not in the cache memory if the instruction will be not be used in the next instruction cycle.

4. The method of claim 1, wherein the cache memory includes an instruction cache memory.

5. A method of executing an instruction in a pipeline processor comprising:
receiving a branching instruction;
predicting a branch;
loading a first instruction into an instruction cache wherein the first instruction is a first occurring instruction from the predicted branch; and
loading a second instruction into a second memory location, wherein the second memory location is not included in the instruction cache, and wherein the second instruction is a first occurring instruction from a non-predicted branch.

6. The method of claim 5, wherein the instruction cache is capable of having the first instruction fetched within one instruction cycle.

7. The method of claim 5, wherein the second memory location is capable of having the second instruction fetched within n instruction cycles.

8. The method of claim 7, wherein n instruction cycles is less than or equal to a number of instruction cycles required to determine if the predicted branch was a correct branch.

9. The method of claim 7, wherein n instruction cycles is greater than or equal to a number of instruction cycles required to determine if the predicted branch was a correct branch.

10. The method of claim 5, further comprising:
fetching the first instruction;
decoding the first instruction;
dispatching the decoded first instruction; and
determining if the predicted branch was a correct branch.

11. The method of claim 10, further comprising:
executing the decoded first instruction if the predicted branch was the correct branch.

12. The method of claim 10, wherein a branch functional unit determines if the predicted branch was a correct branch.

13. The method of claim 10, wherein if the predicted branch was not the correct branch then:
fetching the second instruction,;
decoding the second instruction;
dispatching the decoded second instruction; and
executing the decoded second instruction.

14. A method of executing an instruction in a pipeline processor comprising:
receiving a first instruction;
predicting if the first instruction will cause a stall;
loading the first instruction into an instruction cache if the first instruction will cause a stall; and
loading a second instruction into a second memory location, wherein the second memory location is not included in the instruction cache and wherein the second instruction is a subsequent instruction to the first instruction.

15. The method of claim 14, further comprising:
fetching the first instruction;
decoding the first instruction;
dispatching the decoded first instruction;
executing the decoded first instruction;
retiring the executed first instruction.

16. The method of claim 15, wherein retiring the decoded first instruction includes reordering the result of the executed first instruction.

17. The method of claim 15, wherein dispatching the decoded first instruction includes stalling the pipeline.

18. The method of claim 17, wherein the stall includes fetching the second instruction.

19. The method of claim 15, wherein the decoded first instruction is a load instruction.

20. The method of claim 15, wherein the decoded first instruction is a store instruction.

21. A computer system comprising:
a memory system, wherein the memory system includes:
a mass storage; and
a cache memory, wherein an instruction can be fetched from at least a portion of the cache memory within one instruction cycle;
a processor, wherein the processor includes a first logic and wherein the first logic includes instructions that when executed cause the processor to:
receive an instruction;
determine if the instruction will be used in a next instruction cycle; and
load the instruction in the cache memory if the instruction will be used in the next instruction cycle.

22. The system of claim 21 wherein the processor is an in-order processor.

23. The system of claim 21, wherein the processor is an out-of-order processor.

24. The system of claim 21, wherein the processor is very large instruction word (VLIW) processor.

25. The system of claim 21, wherein the instruction cycle includes no more than two clock cycles.

26. The system of claim 21, wherein the cache memory includes:
an instruction cache wherein the instruction cache and the processor are on one die; and
an n instruction cycle cache.

27. The system of claim 21 wherein the processor includes an instruction pipeline including:
a fetch stage;
a decode stage;
a dispatch stage;
an execution stage; and
a retirement stage.

28. The system of claim 27 wherein the processor is an out of order processor and wherein the retirement stage includes a reorder buffer.

29. The system of claim 27 wherein the execution stage includes:
a plurality of instruction windows; and
a plurality of functional units wherein each one of the plurality of instruction windows corresponds to one of the plurality of functional units.

30. The system of claim 29 wherein the a plurality of instruction windows includes:
a load/store instruction window; and
a branch instruction window.
